(19) United States
(12) Patent Application Publication
(10) Pub. No.: US 2012/0218737 A1
(43) Pub. Date: Aug. 30, 2012

(54) LIGHTING APPARATUS

(75) Inventors: Izuru Komatsu, Kanagawa-ken (JP); Daigo Suzuki, Kanagawa-ken (JP)

(73) Assignee: Kabushiki Kaisha Toshiba, Tokyo (JP)

(21) Appl. No.: 13/404,587

(22) Filed: Feb. 24, 2012

(30) Foreign Application Priority Data
Feb. 28, 2011 (JP) 2011-042630

(51) Int. Cl. F21V 9/16; F21V 7/00

(52) U.S. Cl. 362/84; 362/247

(57) ABSTRACT

A lighting apparatus includes a base unit and a light emitting unit. The light emitting unit includes a substrate, a light emitting device and a reflective layer. The substrate is provided around a first axis which is along a direction from the base unit toward the light emitting unit. The substrate includes a portion having a tubular configuration opening downward from above. The tubular portion includes a plurality of light emission side surfaces disposed alternately around the first axis with a plurality of reflection side surfaces. The light emitting device is provided on each of the plurality of light emission side surfaces. The reflective layer is provided on each of the plurality of reflection side surfaces. The reflective layers are configured to reflect at least a portion of light emitted from the light emitting devices.

### CROSS-REFERENCE TO RELATED APPLICATIONS

This application is based upon and claims the benefit of priority from the prior Japanese Patent Application No. 2011-042630, filed on Feb. 28, 2011; the entire contents of which are incorporated herein by reference.

### FIELD

Embodiments described herein relate generally to a lighting apparatus.

### BACKGROUND

Lighting apparatuses using semiconductor light emitting devices such as light emitting diodes (LEDs) and the like are drawing attention. Because the light radiated from semiconductor light emitting devices has a high tendency to travel in a straight line, the light distribution angles of lighting apparatuses using semiconductor light emitting devices are narrow. A practical lighting apparatus having a wide light distribution angle is desirable.

### BRIEF DESCRIPTION OF THE DRAWINGS

FIG. 1A and FIG. 1B are schematic views illustrating the configuration of a lighting apparatus according to an embodiment;

FIG. 2A and FIG. 2B are schematic views illustrating the configuration of the lighting apparatus according to the embodiment;

FIG. 3A and FIG. 3B are schematic views illustrating the configuration of the lighting apparatus according to the embodiment;

FIG. 4A and FIG. 4B are schematic cross-sectional views illustrating the configuration of the lighting apparatus according to the embodiment;

FIG. 5 is a schematic plan view illustrating the configuration of the lighting apparatus according to the embodiment;

FIG. 6A to FIG. 6C are schematic views illustrating operations of the lighting apparatus according to the embodiment;

FIG. 7A to FIG. 7C are schematic views illustrating the configuration of a lighting apparatus of a first reference example;

FIG. 8A and FIG. 8B are schematic views illustrating the configuration of a lighting apparatus of a second reference example;

FIG. 9A to FIG. 9C are schematic views illustrating the configurations of lighting apparatuses according to the embodiment;

FIG. 10A to FIG. 10D are schematic views illustrating the configurations of lighting apparatuses according to the embodiment; and

FIG. 11A and FIG. 11B are schematic views illustrating the configuration of the lighting apparatus according to the embodiment.

### DETAILED DESCRIPTION

In general, according to one embodiment, a lighting apparatus includes a base unit and a light emitting unit. The light emitting unit includes a substrate, a light emitting device and a reflective layer. The substrate is provided around a first axis which is along a direction from the base unit toward the light emitting unit. The substrate includes a portion having a tubular configuration opening downward from above. The tubular portion includes a plurality of light emission side surfaces disposed alternately around the first axis with a plurality of reflection side surfaces. The light emitting device is provided on each of the plurality of light emission side surfaces. The reflective layer is provided on each of the plurality of reflection side surfaces. The reflective layers are configured to reflect at least a portion of light emitted from the light emitting devices.

Embodiments will now be described with reference to the drawings.

The drawings are schematic or conceptual; and the relationships between the thicknesses and the widths of portions, the proportions of sizes among portions, and the like are not necessarily the same as the actual values thereof. Further, the dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

### EMBODIMENT

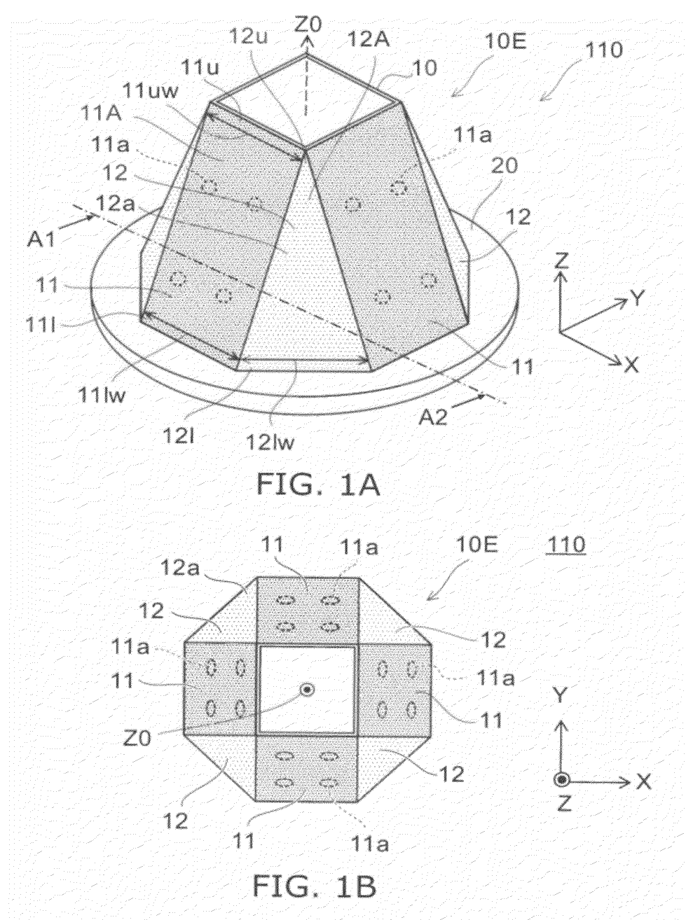

FIG. 1A and FIG. 1B are schematic views illustrating the configuration of a lighting apparatus according to an embodiment.

FIG. 1A is a perspective view; and FIG. 1B is a plan view.

As illustrated in FIG. 1A, the lighting apparatus 110 according to the embodiment includes a base unit 20 and a light emitting unit 10E. The light emitting unit 10E is provided on the base unit 20. The base unit 20 is omitted from FIG. 1B.

A direction from the base unit 20 toward the light emitting unit 10E is taken as a Z-axis direction. One axis perpendicular to the Z axis is taken as an X axis. An axis perpendicular to the Z axis and the X axis is taken as a Y axis. For example, an axis that is perpendicular to the Z axis and passes through the center of a circle circumscribing the light emitting unit 10E when viewed along the Z axis is taken as a central axis Z0.

As illustrated in FIG. 1A and FIG. 1B, the light emitting unit 10E includes a substrate 10, a light emitting device 11a, and a reflective layer 12a.

The substrate 10 includes a portion having a tubular configuration. The tubular portion is provided around one axis (a first axis) along the Z-axis direction. The first axis is, for example, the central axis Z0. The tubular portion opens downward from above. In other words, the diameter (the width in the X-Y plane) of the upper portion of the substrate 10 is smaller than the diameter (the width in the X-Y plane) of the lower portion of the substrate 10.

The tubular portion includes multiple light emission side surfaces 11 and multiple reflection side surfaces 12. The multiple light emission side surfaces 11 and the multiple reflection side surfaces 12 are disposed alternately around the first axis (e.g., the central axis Z0).

Each of the multiple light emission side surfaces 11 is, for example, substantially a plane. Each of the multiple reflection side surfaces 12 is, for example, substantially a plane.

The light emitting device 11a is provided on each of the multiple light emission side surfaces 11. As described below, one or multiple light emitting devices 11a are provided on one light emission side surface 11.

The reflective layer 12a is provided on each of the multiple reflection side surfaces 12. The reflective layer 12a reflects at least a portion of the light emitted from the light emitting devices 11a.

Because the tubular portion opens downward from above, each of the multiple light emission side surfaces 11 is tilted with respect to the central axis Z0. Also, each of the multiple reflection side surfaces 12 is tilted with respect to the central axis Z0.

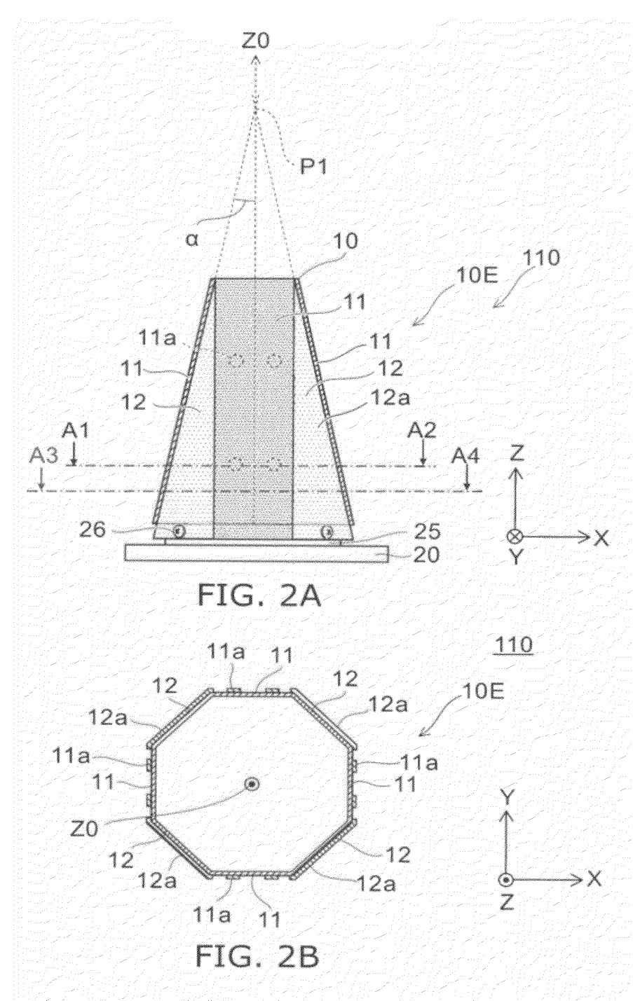

FIG. 2A and FIG. 2B are schematic views illustrating the configuration of the lighting apparatus according to the embodiment.

FIG. 2A is a side view; and FIG. 2B is a cross-sectional view along line A1-A2 of FIG. 1A and FIG. 2A.

As illustrated in FIG. 2A, the planes extending upward as extensions of the light emission side surface 11 intersect the central axis Z0 at, for example, an intersection P1. The angle between the light emission side surface 11 and the central axis Z0 is taken as a tilt angle α. The tilt angle α is, for example, not less than 10 degrees and not more than 40 degrees. In this example, the tilt angle α is 11.3 degrees.

The substrate 10 may include, for example, a flexible substrate. The multiple light emission side surfaces 11 and the multiple reflection side surfaces 12 are set in the flexible substrate. The side surfaces on which the light emitting devices 11a are provided are the light emission side surfaces 11. The side surfaces on which mainly the reflective layers 12a are provided are the reflection side surfaces 12. The flexible substrate is bent at the boundaries between the light emission side surfaces 11 and the reflection side surfaces 12. Thereby, the tubular portion of the substrate 10 is formed.

In other words, as illustrated in FIG. 2B, the tubular portion of the substrate 10 (the multiple light emission side surfaces 11 and the multiple reflection side surfaces 12) is provided around the central axis Z0.

The light emitting device 11a may include, for example, a semiconductor light emitting device. Specifically, the light emitting device 11a includes an LED. For example, the light emitting device 11a includes an LED chip. Also, an LED package including multiple LED chips (including an LED module and the like) may be used.

The reflective layer 12a includes, for example, a white resin layer. The reflective layer 12a includes, for example, a resin and a fine particle (e.g., a particle having scattering properties with respect to visible light) dispersed in the resin. For example, the multiple fine particles are dispersed in the resin. The resin includes, for example, a silicone resin. The fine particle includes, for example, at least one selected from the group consisting of aluminum oxide, titanium oxide, calcium carbonate, zinc sulfide, barium titanate, calcium titanate, and barium sulfate.

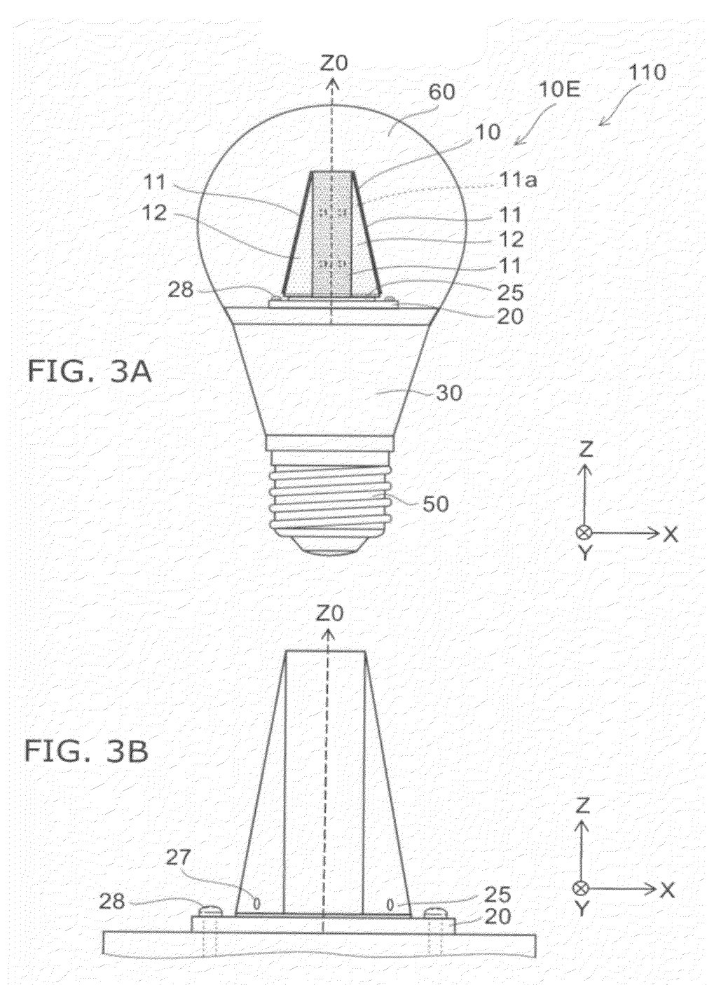

FIG. 3A and FIG. 3B are schematic views illustrating the configuration of the lighting apparatus according to the embodiment.

FIG. 3A is a side view illustrating an example of the overall configuration of the lighting apparatus according to the embodiment. FIG. 3B is a side view illustrating the configuration of parts of a portion of the lighting apparatus according to the embodiment.

As illustrated in FIG. 3A, the lighting apparatus 110 may further include a body 30, a base cap 50, and an enclosure 60.

The base unit 20 is disposed on the body 30. For example, a power source unit (not illustrated) configured to drive the light emitting devices 11a is contained in the interior of the body 30. The base cap 50 is mounted to the lower portion of the body 30. The current that is the origin of the current supplied to the light emitting unit 10E is supplied to the lighting apparatus 110 via the base cap 50. The base cap 50 also functions to fix the lighting apparatus 110 to other appliances.

The enclosure 60 is, for example, a globe. The enclosure 60 covers the upper portion and the side portion of the light emitting unit 10E. In other words, the enclosure 60 covers the portion of the light emitting unit 10E excluding the portion connected to the base unit 20. The enclosure 60 is transparent.

The base unit 20 is fixed to, for example, the body 30 by a base unit fixation member 28. The base unit fixation member 28 includes, for example, a screw and the like. The base unit fixation member 28 is omitted from FIG. 1A and FIG. 1B.

The light emitting unit 10E is mounted, for example, on a pedestal 25 provided on the base unit 20. The pedestal 25 is omitted from FIG. 1A and FIG. 1B.

FIG. 3B illustrates the configuration of the pedestal 25. As illustrated in FIG. 3B, the width of the upper portion of the pedestal 25 is smaller than the width of the lower portion. The side surfaces of the pedestal 25 are designed to contact the back side surfaces of the substrate 10. The back side surfaces of the substrate 10 are the side surfaces opposite to the light emission side surfaces 11 and the side surfaces opposite to the reflection side surfaces 12. An adhesive sheet having high thermal conductivity is provided, for example, between the substrate 10 and the pedestal 25. Thereby, the substrate 10 and the pedestal 25 are thermally coupled to each other.

In this example, the substrate 10 is fixed to the pedestal 25 by, for example, a fixation member such as a screw and the like. For example, a substrate fixation unit 27 (e.g., a screw hole and the like) is provided in the lower portion of the pedestal 25; and the substrate 10 is fixed to the pedestal 25 by a substrate fixation member 26 (e.g., a screw and the like) illustrated in FIG. 2A. The substrate fixation member 26 is omitted from FIG. 1A and FIG. 1B.

For example, the heat generated at the light emitting device 11a on the substrate 10 is dissipated via the pedestal 25. The pedestal 25 includes, for example, a metal. The pedestal includes, for example, aluminum. Thereby, the heat dissipation can be improved.

Although there are four light emission side surfaces 11 and four reflection side surfaces 12 in the lighting apparatus 110 illustrated in these drawings, the number of the light emission side surfaces 11 and the number of the reflection side surfaces 12 are arbitrary.

In this example, the light emission side surface 11 is a rectangle; and the reflection side surface 12 is a triangle. However, the embodiment is not limited thereto as described below.

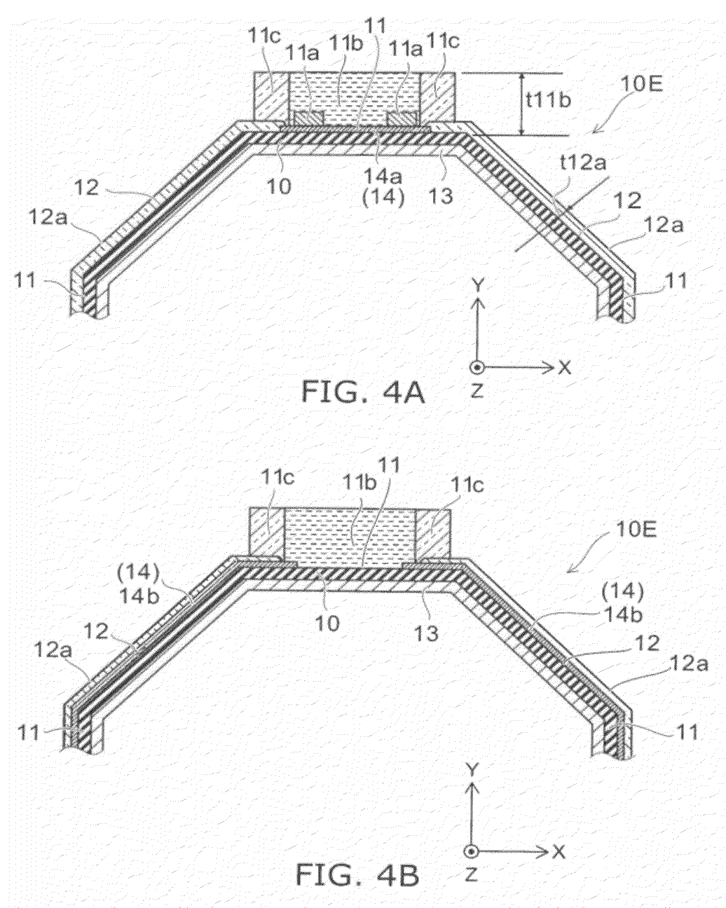

FIG. 4A and FIG. 4B are schematic cross-sectional views illustrating the configuration of the lighting apparatus according to the embodiment.

Namely, FIG. 4A illustrates a portion of the cross section along line Al-A2 of FIG. 2A. FIG. 4B illustrates a portion of the cross section along line A3-A4 of FIG. 2A.

As illustrated in FIG. 4A and FIG. 4B, the substrate 10 is bent. The substrate 10 includes, for example, a flexible substrate such as a polyimide resin and the like.

The surfaces of the substrate 10 on the sides on which the light emitting devices 11a of the light emission side surfaces 11 are provided and the surfaces of the substrate 10 on the sides on which the reflective layers 12a of the reflection side surfaces 12 are provided are called outer surfaces. The surfaces on the sides opposite to the outer surfaces are called inner surfaces.

A conductive layer 14 is provided on a portion of an outer surface of the substrate 10. For example, a portion of the conductive layer 14 is used as an electrode layer 14a on the light emission side surface 11. The electrode layer 14a is electrically connected to the light emitting device 11a. The electrical connections between the electrode layer 14a and the light emitting device 11a may be direct connections, may be connected by connection members (e.g., bonding wires and the like), and may be a connection of any configuration. For example, another portion of the conductive layer 14 is used as an interconnect layer 14b on the reflection side surface 12. The interconnect layer 14b is connected to, for example, the electrode layer 14a. Thus, the light emitting unit 10E may further include the interconnect layer 14b provided on the reflection side surface 12. The interconnect layer 14b is electrically connected to the light emitting device 11a. The electrode layers 14a of the multiple light emission side surfaces 11 may be connected to each other by the interconnect layers 14b of the reflection side surfaces 12.

The conductive layer 14 includes, for example, an aluminum layer provided on the substrate 10. The aluminum layer is formed of, for example, a foil. The conductive layer 14 may have a stacked structure of a copper layer provided on the substrate 10, a nickel layer provided on the copper layer, and an aluminum layer provided on the nickel layer. Or, the conductive layer 14 may have a stacked structure of, for example, a copper layer provided on the substrate 10, a nickel layer provided on the copper layer, a palladium layer provided on the nickel layer, and an aluminum layer provided on the palladium layer. In the case where the aluminum layer is provided on the nickel layer or the palladium layer, the aluminum layer is formed using, for example, sputtering and the like. However, the embodiment is not limited thereto. The configuration of the conductive layer 14 and the material of the conductive layer 14 are arbitrary.

A high reflectance is obtained by using a silver layer as the upper layer of the conductive layer 14. Such a silver layer may be provided, for example, on the entire conductive layer 14. Such a silver layer may be omitted from, for example, the portions of the conductive layer 14 where the light emitting devices 11a (and the interconnects connected to the light emitting devices 11a) are disposed (the portions where the light is shielded).

The light emitting device 11a is provided on the light emission side surface 11. In this example, the light emitting device 11a is provided on the electrode layer 14a.

In the case where an LED chip is used as the light emitting device 11a, for example, the electrodes of the LED chip (or connection members electrically connected to the electrodes of the LED chip) are connected to portions of the electrode layer 14a. For example, in the case where an LED package is used as the light emitting device 11a, the electrodes of the LED package are connected to the electrode layer 14a.

The light emitting unit 10E may further include a wavelength conversion layer 11b. The wavelength conversion layer 11b is provided on the multiple light emission side surfaces 11 and covers the light emitting layers of the light emitting devices 11a. The wavelength conversion layer 11b absorbs at least a portion of the light emitted from the light emitting layers of the light emitting devices 11a and emits light of a wavelength different from the wavelength of the emitted light. The wavelength conversion layer 11b may include, for example, a fluorescer layer. In the case where an LED chip is used as the light emitting device 11a, the light emitting layer of the light emitting device 11a corresponds to a layer (a semiconductor stacked body) included in the LED chip.

For example, the light emitting layer of the light emitting device 11a emits light of a relatively short wavelength. The wavelength conversion layer 11b absorbs a portion of the emitted light and converts the emitted light to light of a long wavelength. Thereby, the lighting apparatus 110 emits, for example, white light. The white light includes violet-tinted white light, bluish white light, greenish white light, yellowish white light, and reddish white light.

In the case where an LED package is used as the light emitting device 11a, there are many cases where the light emitting layer of the light emitting device 11a (the semiconductor light emitting layer of the LED chip) and a fluorescer layer (corresponding to the wavelength conversion layer) that covers the light emitting layer are provided inside the LED package.

The light emitting unit 10E further includes an outer edge layer 11c. The outer edge layer 11c is provided along the outer edge of each of the multiple light emission side surfaces 11. The wavelength conversion layer 11b is filled into the inner side of the outer edge layer 11c of each of the multiple light emission side surfaces 11. For example, first, the outer edge layer 11c is formed on the light emission side surface 11; and the wavelength conversion layer 11b is formed subsequently by filling the wavelength conversion layer 11b into the region around which the outer edge layer 11c is provided. Thereby, the wavelength conversion layer 11b can be formed with high precision and productivity.

The outer edge layer 11c includes, for example, a resin that is transmissive with respect to visible light and the like. For example, the light emitted from the light emitting device 11a becomes white light due to the wavelength conversion layer 11b. The light (the white light) is emitted to the outside from the upper surface of the wavelength conversion layer 11b and emitted to the outside through the outer edge layer 11c.

The outer edge layer 11c may be formed by the same material as the material used for the wavelength conversion layer 11b. The outer edge layer 11c may not include the wavelength conversion layer. The wavelength conversion layer 11b may be filled after forming the outer edge layer 11c. Further, the wavelength conversion layer 11b and the outer edge layer 11c may be formed by a batch processing.

The reflective layer 12a is provided on the reflection side surface 12. The reflective layer 12a covers at least a portion of the interconnect layer 14b.

As illustrated in FIG. 4A and FIG. 4B, the reflective layer 12a may be provided not only on the reflection side surface 12 but also in a portion of the light emission side surface 11. For example, the reflective layer 12a may include a portion extending from the reflection side surface 12 onto at least a portion of the outer edge portion of the light emission side surface 11. Thereby, the light can be reflected more effectively.

A heat dissipation layer 13 is provided on the inner surface of the substrate 10. The reflection side surface 12 is disposed between the heat dissipation layer 13 and the reflective layer 12a. The heat dissipation layer 13 includes, for example, a metal. The heat dissipation layer 13 includes, for example, a material such as copper, aluminum, and the like. The heat dissipation layer 13 conducts the heat generated at the light emitting device 11a toward the pedestal 25 on which the light emitting unit 10E is disposed. The heat dissipation is improved by providing the heat dissipation layer 13.

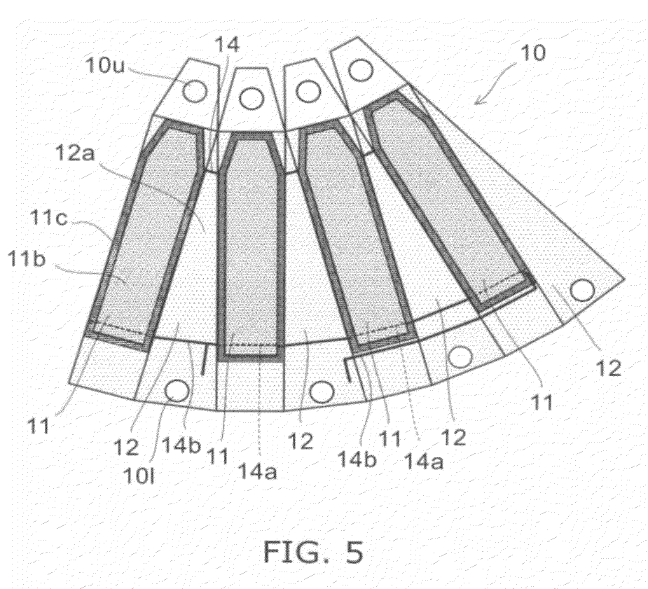

FIG. 5 is a schematic plan view illustrating the configuration of the lighting apparatus according to the embodiment.

FIG. 5 illustrates the state prior to the substrate 10 being formed in a tubular configuration. In other words, this drawing illustrates the state in which the substrate 10 is unfolded.

As illustrated in FIG. 5, the substrate 10 as an entirety has a substantially fan-like configuration. For example, the rectangular light emission side surfaces 11 are alternately juxtaposed with the triangular reflection side surfaces 12 around one central point. By using such a configuration, the tubular portion is formed by bending the substrate 10. Thus, the light emission side surfaces 11 and the reflection side surfaces 12 of the substrate 10 are provided continuously. Thereby, the electrode layers 14a of the light emission side surfaces 11 are connected to each other by the interconnect layers 14b without using other interconnects.

As illustrated in FIG. 5, the outer edge layer 11c is provided on the outer edge portion of the light emission side surface 11. The wavelength conversion layer 11b is provided inside the region around which the outer edge layer 11c is provided.

As illustrated in FIG. 5, for example, an upper hole 10u is provided in the upper side of the light emission side surface 11; and a lower hole 101, which is a through-hole, is provided in the lower side of the light emission side surface 11. In this example, the lower hole 101 is provided in the lower portion of the reflection side surface 12. In this example, the reflective layer 12a extends onto the lower portion of the light emission side surface 11 (e.g., the portion of the reflection side surface 12 at the height where the lower hole 101 is provided). The substrate 10 is fixed to the pedestal 25 by, for example, the substrate fixation members 26 (the screws, etc.) using the upper hole 10u and the lower hole 101. Thus, the light emitting unit 10E is fixed to the base unit 20 through a through-hole (in this example, the lower hole 101).

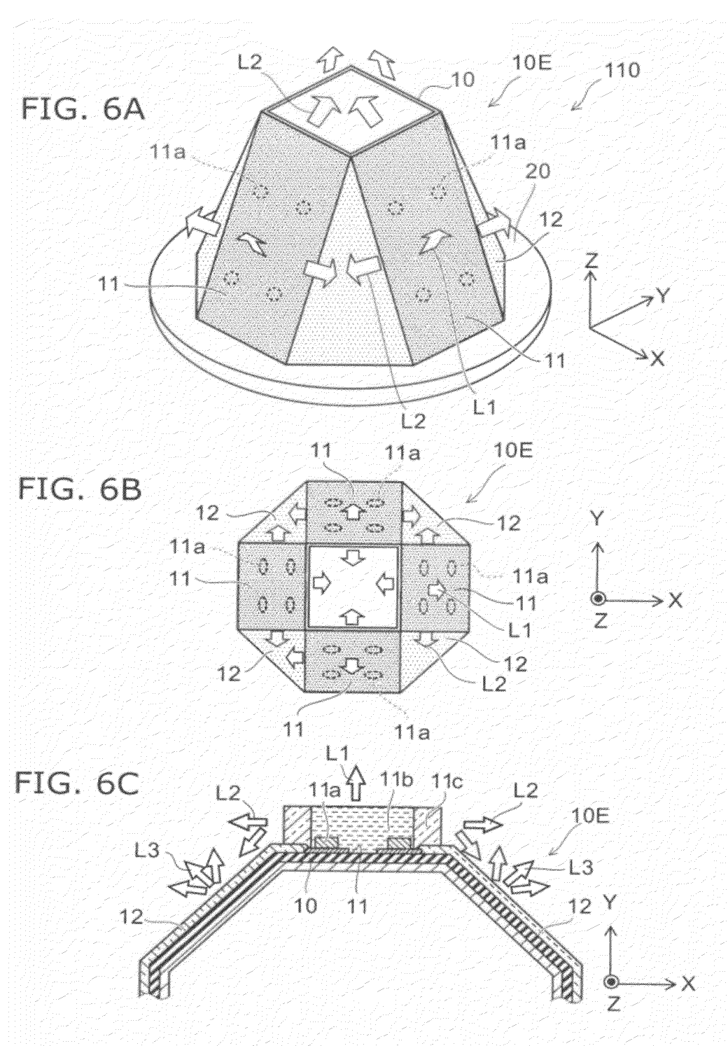

FIG. 6A to FIG. 6C are schematic views illustrating operations of the lighting apparatus according to the embodiment. In the lighting apparatus 110 as illustrated in FIG. 6A and FIG. 6B, a first light L1 is emitted from the major surface of the light emission side surface 11 (e.g., from the major surface of the wavelength conversion layer 11b). A second light L2 is emitted from the light emission side surface 11 (e.g., from the outer edge layer 11c) in the side-surface direction. The second light L2 is emitted mainly along a direction (a side-surface direction) parallel to the light emission side surface 11.

As illustrated in FIG. 6C, a portion of the second light L2 travels toward the reflection side surface 12 and is reflected by the reflective layer 12a to become a third light L3.

Thus, in the lighting apparatus 110 according to the embodiment, the light distribution angle is wide due to the first to third light L1 to L3 being emitted. In other words, uniform light is radiated over a wide range.

As described above, the lighting apparatus 110 includes the light emission side surfaces 11 where the light emitting devices 11a are provided and the reflection side surfaces 12 where the light emitting devices 11a are not provided. Thereby, the flexibility of the design increases. Also, the various constraints of the manufacturing processes can be fewer; and the manufacturing is easier.

For example, the electrical connection terminals of the electrodes (the electrode layer 14a) connected to the light emitting device 11a can be provided on the end of the reflection side surface 12 instead of the light emission side surface 11. Thereby, for example, the region in which the light emitting devices 11a are disposed on the light emission side surface 11 can be enlarged. In other words, the degrees of freedom of the design inside the light emission side surface 11 increase by the light emission side surface 11 and the reflection side surface 12 being separate.

A region for the fixation (e.g., the region where the lower hole 101, etc., illustrated in FIG. 5 are provided) is provided in the substrate 10 for mounting the substrate 10 to the pedestal 25 (or the base unit 20). In such a case, in the embodiment, this region for the fixation can be provided on the reflection side surface 12 instead of the light emission side surface 11. Because functional devices such as the light emitting device 11a and the like are not provided on the reflection side surface 12, the constraints relating to the substrate fixation to avoid negative effects on the functional devices are relaxed.

Also, for example, when attaching the screw for the fixation (the base unit fixation member 28) in the process of fixing the base unit 20 to the body 30, the risk of scratching the light emitting device 11a of the light emission side surface 11 during the mounting operation is reduced by setting the mounting portion of the screw to be the portion corresponding to the reflection side surface 12. Also, the risk of scratching the wavelength conversion layer 11b, the outer edge layer 11c, and the like in this process is reduced. In other words, the constraints of the manufacturing processes decrease.

Thus, in the embodiment, the flexibility increases for the design of the light emission side surface 11, the design of the electrical connections, the design for fixing the substrate 10, and the like. Then, the margins of the fixation process of the substrate 10 and the fixation process of the base unit 20 can be increased. As a result, the lighting apparatus 110 can be downsized. Thus, the practical usability of the embodiment is high.

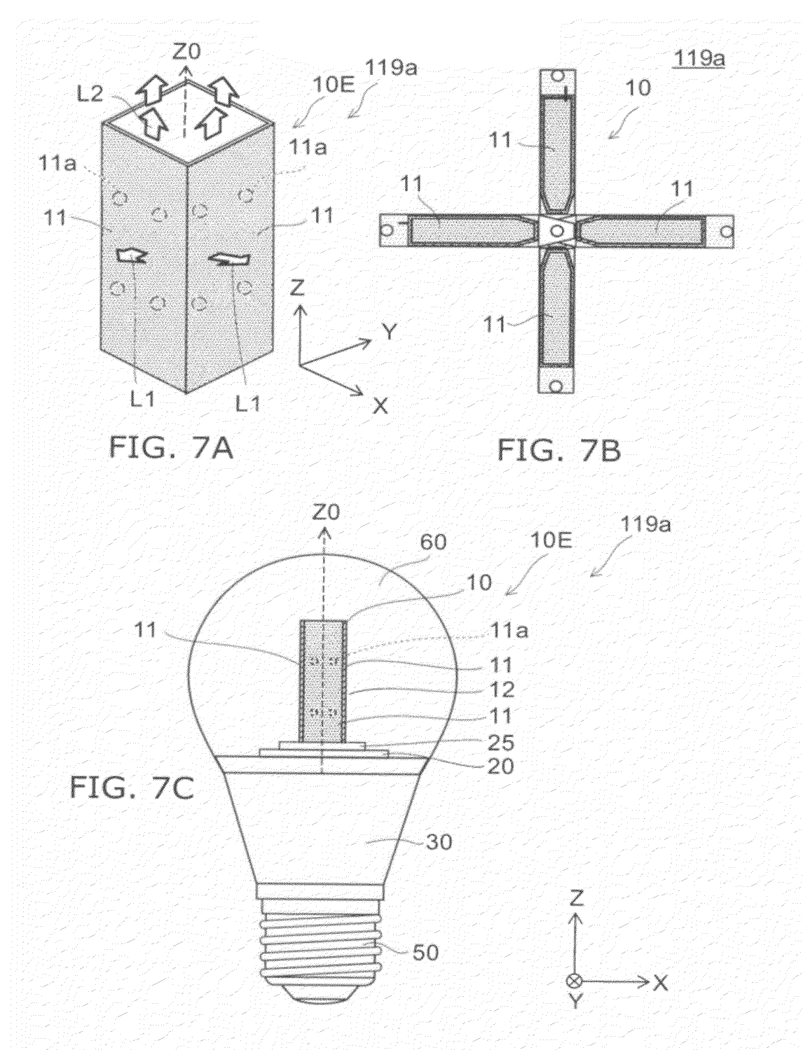

FIG. 7A to FIG. 7C are schematic views illustrating the configuration of a lighting apparatus of a first reference example.

FIG. 7A illustrates the light emitting unit 10E of the lighting apparatus 119a of the first reference example. The base unit 20 is omitted from these drawings. FIG. 7B illustrates the state in which the substrate 10 is unfolded. FIG. 7C illustrates the configuration of the entire lighting apparatus 119a.

Although the substrate 10 of the light emitting unit 10E has a tubular configuration in the lighting apparatus 119a as illustrated in FIG. 7A to FIG. 7C, the diameter (the width) of the upper portion is equal to the diameter (the width) of the lower portion. Only the light emission side surface 11 is provided; and the reflection side surface is not provided. The light emission side surface 11 is parallel to the central axis Z0 and is not tilted.

As illustrated in FIG. 7A, in such a case, the first light L1 is emitted from the light emission side surfaces 11; and the second light L2 is emitted from the side surfaces. The first light L1 travels mainly along the X-Y plane. The second light L2 travels along the Z axis. Therefore, for example, a region exists above the center of the light emitting unit 10E into which the first light L1 and the second light L2 do not enter (or where the intensity of the light is weak). Therefore, the brightness of the lighting apparatus 119a is nonuniform.

In the lighting apparatus 119a as illustrated in FIG. 7B, the multiple light emission side surfaces 11 are disposed in a radial configuration in the state in which the substrate 10 is unfolded (i.e., the state prior to the substrate 10 being formed in the tubular configuration). A space exists between the multiple light emission side surfaces 11 which are disposed around the center of the radial configuration. In the case where the substrate 10 is provided continuously, this space is a portion removed from the sheet used to form the substrate 10. In other words, the material usage efficiency is low. In the case where the substrate 10 is formed by combining multiple sheets used to form the light emission side surface 11, a process of forming the substrate 10 is necessary; the processes are complex; and the productivity is low.

Thus, in the lighting apparatus 119a of the first reference example, the brightness is nonuniform. Also, the material usage efficiency is low; or the processes are complex and the productivity is low. Because each of the four side surfaces are the light emission side surface 11, the flexibility of the design is low; and the margins of the manufacturing processes also are low. In other words, the practical usability is low.

Conversely, in the lighting apparatus 110 according to the embodiment, the light emission side surfaces 11 and the reflection side surfaces 12 are tilted with respect to the Z axis; and, for example, at least one selected from the second light L2 and the first light L1 enters the region above the center of the light emitting unit 10E. Further, the light is effectively reflected by using the third light L3 reflected at the reflective layer 12a; and the light spreads further. Thus, in the embodiment, the light distribution angle can be wide.

As illustrated in FIG. 5, the substrate 10 as an entirety has a substantially fan-like configuration in the state in which the substrate 10 is unfolded; and the light emission side surfaces 11 and the reflection side surfaces 12 are continuous and integral. Therefore, the material usage efficiency is high; the processes are easy; and the productivity is high. Then, the flexibility of the design is high; and the margins of the manufacturing processes also are wide.

Thus, according to the embodiment, a practical lighting apparatus having a wide light distribution angle can be provided.

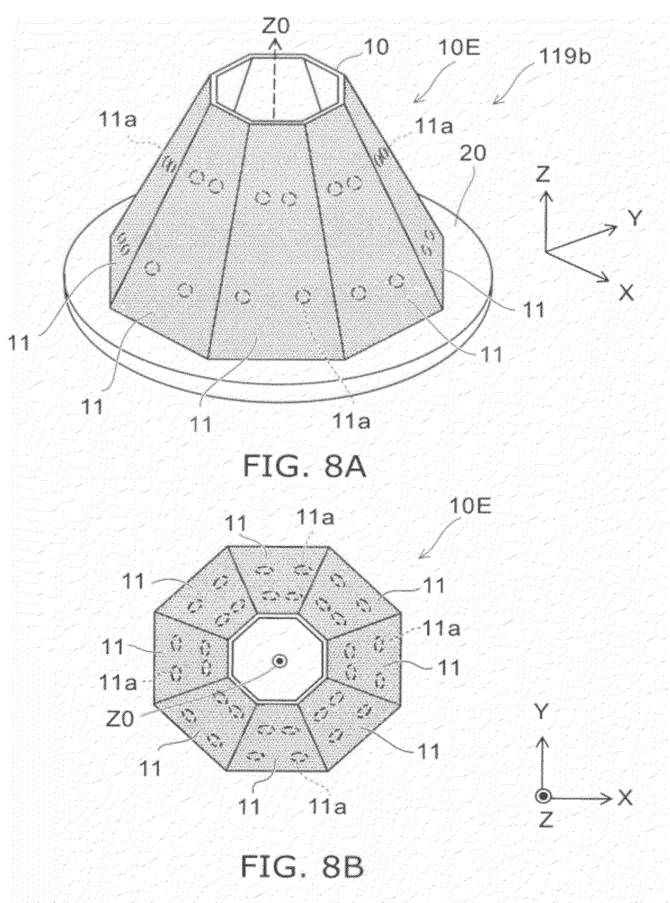

FIG. 8A and FIG. 8B are schematic views illustrating the configuration of a lighting apparatus of a second reference example.

FIG. 8A is a schematic perspective view; and FIG. 8B is a schematic plan view.

In the lighting apparatus 119b of the second reference example as illustrated in FIG. 8A and FIG. 8B, the tubular portion of the substrate 10 opens downward from above. Namely, the tubular portion has a truncated octagonal pyramid configuration (a truncated polygonal pyramid configuration). Only the light emission side surfaces 11 are provided; and the reflection side surfaces are not provided. Each of the light emission side surfaces 11 is a trapezoid. In these trapezoids, the length of the upper side is markedly shorter than the length of the lower side. The light emission side surface 11 is tilted with respect to the Z axis.

In the lighting apparatus 119b, there is a possibility that a wide light distribution angle may be obtained because the light emission side surfaces 11 are tilted. However, the practical usability of the lighting apparatus 119b is insufficient. Namely, each of the side surfaces of the lighting apparatus 119b is the light emission side surface 11. Therefore, the flexibility of the design is low; and the margins of the manufacturing processes also are low.

Configurations in which the light emission side surfaces 11 are parallel to the central axis as in the first reference example have been proposed as conventional LED electric bulbs. To increase the uniformity of the light of such configurations, there are configurations in which the light emission side surfaces 11 are tilted as in the second reference example. In such conventional configurations, each of the side surfaces of the substrate 10 is the light emission side surface 11.

However, according to investigations of the inventor, it was learned that the practical usability of the configurations recited above is insufficient. In other words, to make the LED electric bulb more practical, it was learned that it is necessary to increase the flexibility of the design of the light emission side surfaces, the electrical connections, and the substrate fixation and increase the margins of the manufacturing processes. Regarding these points, the conventional configurations are insufficient. The inventor discovered new problems by focusing on such practical usability. The configuration of the embodiment solves these problems. In other words, according to the embodiment, a lighting apparatus can be provided in which the lighting apparatus has a wide light distribution angle, the productivity is high, the flexibility of the design is high, and the margins of the processes are wide.

In the embodiment, the light emitting devices 11a can be disposed more appropriately inside the light emission side surface 11 by the light emission side surface 11 being a rectangle (a trapezoid that is nearly a rectangle). In other words, it is desirable for multiple light emitting devices 11a to be disposed, for example, at uniform spacing in the case where multiple light emitting devices 11a are provided on one light emission side surface 11. Thereby, the efficiency of the mounting of the light emitting devices 11a (including, e.g., the mounting of the LED chips, the wire bonding, the mounting of the LED packages, and the like) improves.

In the lighting apparatus 119b in which the tubular portion has a truncated polygonal pyramid configuration and the light emission side surface 11 is a trapezoid, the number of the light emitting devices 11a juxtaposed in the vertical direction inside the light emission side surface 11 must change in the case where the spacing of the light emitting devices 11a is constant. For example, in the case where the light emitting devices 11a juxtaposed in the vertical direction are connected in series, the brightness undesirably differs by column because the number of the light emitting devices 11a connected in series is different. Therefore, the brightness is nonuniform.

Conversely, in the lighting apparatus 119b as illustrated in FIGS. 8A and 8B, the efficiency of the mounting of the light emitting devices 11a decreases in the case where the spacing of the light emitting devices 11a of the upper portion of the light emission side surface 11 is smaller than the spacing of the light emitting devices 11a of the lower portion. Then, there are cases where the temperature increases excessively at the upper portion of the light emission side surface 11 because the spacing of the light emitting devices 11a is small at the upper portion.

Conversely, in the lighting apparatus 110 according to the embodiment, the multiple light emitting devices 11a can be disposed at uniform spacing in the case where the light emission side surface 11 is a rectangle or a trapezoid that is nearly a rectangle. Thereby, the efficiency of the mounting of the light emitting device 11a is high. The excessive temperature increase is suppressed because there are no portions where the spacing of the light emitting devices 11a is excessively small.

In other words, in the embodiment, the tilt angles of the light emission side surfaces 11 can be easily modified by the design of the reflection side surfaces 12. Therefore, in the design inside the light emission side surface 11, the light emitting devices 11a can be designed to be disposed optimally. In other words, as a result, excellent light emission characteristics can be realized by a simple design because the tilt angle and the disposition of the light emitting devices 11a can be designed independently. Conversely, for example, in the second reference example, it is difficult to realize both the optimal tilt and the optimal disposition of the light emitting devices 11a because these functions are not separate. Thus, according to the embodiment, a practical lighting apparatus having a wide light distribution angle can be provided.

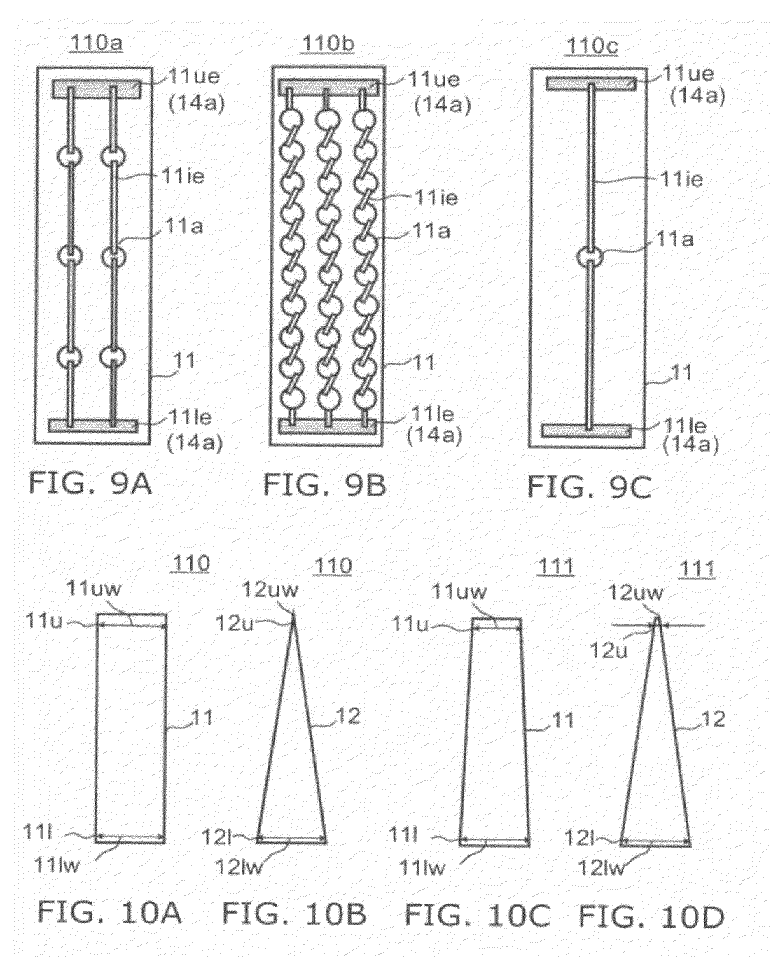

FIG. 9A to FIG. 9C are schematic views illustrating the configurations of lighting apparatuses according to the embodiment.

These drawings illustrate an example of the disposition of the light emitting devices 11a of the light emission side surface 11.

In the lighting apparatus 110a according to the embodiment as illustrated in FIG. 9A, six light emitting devices 11a are provided in one light emission side surface 11. In this example, three light emitting devices 11a that are juxtaposed in the vertical direction are connected in series by an interconnect 11ie. One end of the circuit having the three connected light emitting devices 11a is connected to an upper electrode 11ue. The other end of the circuit is connected to a lower electrode 111e. Multiple columns (columns of three light emitting devices 11a) are provided between the two electrodes. The number of the light emitting devices 11a of each column is the same (in this example, three). For example, the electrode layer 14a (the conductive layer 14) is used for the upper electrode 11ue and the lower electrode 11le.

In the lighting apparatus 110b according to the embodiment as illustrated in FIG. 9B, thirty light emitting devices 11a are provided in one light emission side surface 11. In this example, ten light emitting devices 11a that are juxtaposed in the vertical direction are connected in series by the interconnect 11ie. Three columns (in this example, columns including ten light emitting devices 11a) are provided between the upper electrode 11ue and the lower electrode 11le. The number of the light emitting devices 11a of one column is the same (in this example, ten).

Thus, in the embodiment, for example, the light emitting device 11a is multiply provided in each of the multiple light emission side surfaces 11. It is desirable for the multiple light emitting devices of each of the multiple light emission side surfaces 11 to be disposed at uniform spacing. Thereby, high productivity is obtained.

In the case where the light emitting device 11a is multiply provided in each of the light emission side surfaces 11, a first group of the multiple light emitting devices 11a is connected in series to each other; and a second group of the multiple light emitting devices 11a is connected in series to each other. The number of the light emitting devices 11a included in the first group is substantially the same as the number of the light emitting devices 11a included in the second group. In other words, the number of the light emitting devices 11a connected in series is the same. Thereby, the brightness of the first group is the same as the brightness of the second group. In other words, a uniform brightness is obtained.

In the light emission side surface 11, the number of the light emitting devices 11a juxtaposed in the vertical direction is arbitrary. Also, the number of the light emitting devices 11a juxtaposed in the lateral direction is arbitrary.

As illustrated in FIG. 9C, one light emitting device 11a may be provided in one light emission side surface 11.

In the lighting apparatuses 110a to 110c as well, a practical lighting apparatus having a wide light distribution angle can be provided.

Although an example is illustrated in FIG. 5 in which the lower hole 101 is provided in the lower portion of the reflection side surface 12, the embodiment is not limited thereto. For example, the lower hole 101 may be provided in a portion of the light emission side surface 11. The method for mounting the substrate 10 to the base unit 20 is arbitrary.

Examples of configurations of the light emission side surface 11 and the reflection side surface 12 according to the embodiment will now be described.

As illustrated in FIG. 1A, for example, one of the multiple light emission side surfaces 11 is taken as a first light emission side surface 11A. One of the multiple reflection side surfaces 12 is taken as a first reflection side surface 12A.

The first light emission side surface 11A has a light emission side surface width along a direction perpendicular to the first axis (e.g., the central axis Z0). The light emission side surface width at the upper portion (e.g., the upper end) is a light emission side surface upper portion width 11uw. The light emission side surface width at the lower portion (e.g., the lower end) is a light emission side surface lower portion width 11lw

The first reflection side surface 12A has the reflection side surface width along the direction perpendicular to the first axis. The reflection side surface width at the upper portion (e.g., the upper end) is a reflection side surface upper portion width 12uw. The reflection side surface width at the lower portion (e.g., the lower end) is a reflection side surface lower portion width 12lw.

In the embodiment, the ratio of the light emission side surface upper portion width 11uw to the light emission side surface lower portion width 11lw is higher than the ratio of the reflection side surface upper portion width 12uw to the reflection side surface lower portion width 12lw.

FIG. 10A to FIG. 10D are schematic views illustrating the configurations of lighting apparatuses according to the embodiment.

These drawings illustrate examples of the planar configurations of the light emission side surface 11 and the reflection side surface 12.

In a lighting apparatus 110 as described above as illustrated in FIG. 10A and FIG. 10B, the light emission side surface 11 is a rectangle; and the reflection side surface 12 is a triangle. In such a case, the ratio of the reflection side surface upper portion width 12uw (e.g., the width of the upper end) to the reflection side surface lower portion width 12lw (e.g., the width of the lower end) is 0. In other words, the ratio of the light emission side surface upper portion width 11uw to the light emission side surface lower portion width 11lw is higher than the ratio of the reflection side surface upper portion width 12uw to the reflection side surface lower portion width 12lw.

Although the configuration of the light emission side surface 11 of the lighting apparatus 110 is a rectangle, the configuration of the light emission side surface 11 includes rectangles with rounded corners. Also, the configuration of the light emission side surface 11 includes polygons formed by corners being cut off rectangles.

In a lighting apparatus 111 according to the embodiment as illustrated in FIG. 10C and FIG. 10D, the light emission side surface 11 and the reflection side surface 12 are trapezoids. The light emission side surface 11 has a configuration that is nearly a rectangle; and the reflection side surface 12 has a configuration that is nearly a triangle. The width of the upper portion of the light emission side surface 11 is wider than the width of the upper portion of the reflection side surface 12. In other words, in such a case as well, the ratio of the light emission side surface upper portion width 11uw to the light emission side surface lower portion width 11lw is higher than the ratio of the reflection side surface upper portion width 12uw to the reflection side surface lower portion width 12lw. In such a case as well, the configuration of the light emission side surface 11 includes trapezoids with rounded corners. The configuration of the light emission side surface 11 includes polygons formed by corners being cut off trapezoids.

In the embodiment, the ratio of the light emission side surface upper portion width 11uw (e.g., the width of the upper end) to the light emission side surface lower portion width 11lw (e.g., the width of the lower end) is set to be, for example, not less than 0.8 and not more than 1. In other words, by the light emission side surface 11 being a rectangle or a trapezoid that is nearly a rectangle, the multiple light emitting devices 11a can be disposed at uniform spacing; and the efficiency of the mounting can be increased. The excessive temperature increase can be suppressed because there are no portions where the spacing of the light emitting devices 11a is excessively small.

On the other hand, the ratio of the reflection side surface upper portion width 12uw (e.g., the width of the upper end) to the reflection side surface lower portion width 12lw (e.g., the width of the lower end) is set to be not less than 0 and not more than 0.5. In other words, by the reflection side surface 12 being a triangle or a trapezoid that is nearly a triangle, the light emission side surface 11 connected to the reflection side surface 12 can be tilted with respect to the Z axis. Thereby, a region can exist above the center of the light emitting unit 10E into which the first light L1 and the second light L2 enter.

By the reflection side surface 12 having a configuration as near as possible to a triangle, the size of the light emitting unit 10E can be reduced. In the case where the reflection side surface 12 is a triangle, the effect of reducing the size of the light emitting unit 10E is particularly large. By the reflection side surface 12 being a triangle, the total surface area of the substrate 10 can be reduced. Therefore, it is particularly favorable for the reflection side surface 12 to be a triangle.

Specific examples of the wavelength conversion layer 11b and the reflective layer 12a will now be described.

As illustrated in FIG. 4A, a thickness t11b of the wavelength conversion layer 11b is, for example, not less than 500 micrometers (μm) and not more than 1500 μm. Thereby, the light emitted from the light emitting device 11a can be converted to white light with a high efficiency. For example, the thickness t11b of the wavelength conversion layer 11b is not less than 800 μm and not more than 900 μm. However, the embodiment is not limited thereto. The thickness t11b of the wavelength conversion layer 11b is arbitrary.

It is favorable for a thickness t12a of the reflective layer 12a to be, for example, not less than 20 μm and not more than 50 μm. When the thickness t12a of the reflective layer 12a is thinner than 20 μm, there are cases where the ability to reflect light is low. When the thickness t12a of the reflective layer 12a is thicker than 50 μm, there are cases where, for example, the flexibility of the stacked structure of the substrate 10 and the reflective layer 12a is low.

For example, the substrate 10 is bent after the reflective layer 12a is provided on the substrate 10. In such a case, if the thickness t12a of the reflective layer 12a is excessively thick in the case where the reflective layer 12a extends from the reflection side surface 12 onto the light emission side surface 11, the formability of the substrate 10 is poor, or in some cases, the reflective layer 12a may break. By setting the thickness t12a of the reflective layer 12a appropriately, a high formability can be obtained; and the breakage of the reflective layer 12a can be suppressed.

It is desirable for a resin material that does not easily crack when bent to be used as the reflective layer 12a. Thereby, the occurrence of cracks and the like during the bending is suppressed. By using a silicone resin as the reflective layer 12a, the occurrence of such cracks is easily suppressed. However, the embodiment is not limited thereto. The material used as the resin of the reflective layer 12a is arbitrary.

It is favorable for the diameter (e.g., the average of the diameter) of the fine particles dispersed in the resin of the reflective layer 12a to be not less than 0.1 μm. Thereby, the light-scattering efficiency increases; and a high reflectance is easily obtained. However, the embodiment is not limited thereto. The diameter is arbitrary.

It is favorable for the thickness t11b of the wavelength conversion layer 11b to be thicker than the thickness t12a of the reflective layer 12a. By setting the thickness t11b of the wavelength conversion layer 11b to be thicker than the thickness t12a of the reflective layer 12a, a portion of the light emitted from the upper portion of the wavelength conversion layer 11b is appropriately incident on the reflective layer 12a and is efficiently reflected. Thereby, the reflective characteristics improve; and the light distribution property improves.

By setting the wavelength conversion layer 11b and the reflective layer 12a to have conditions such as those recited above, sufficient wavelength conversion characteristics of the light emission side surface 11 are obtained; and a reflective layer 12a is obtained that is not broken easily even when the substrate 10 is bent.

In the embodiment, the conductive layer 14 provided in the outer surface of the substrate 10 may be used for the electrical connections. On the other hand, the heat dissipation layer 13 that is provided in the inner surface of the substrate 10 is provided for heat dissipation. It is favorable for the conductive layer 14 to include, for example, a Cu layer and for the thickness of the conductive layer 14 to be, for example, not less than 12 μm and not more than 70 μm. By setting the thickness to be not less than 12 μm, for example, it is easy to obtain good electrical connectability (to ensure the permissible current). The flexibility is good by setting the thickness to be not more than 70 μm. However, the embodiment is not limited thereto. The thickness is arbitrary.

It is favorable for the thickness of the heat dissipation layer 13 to be, for example, thicker than 13 μm. Thereby, good heat dissipation is easily obtained. However, the embodiment is not limited thereto. The thickness is arbitrary.

Thus, the light emitting unit 10E may further include: the conductive layer 14 that is provided on the reflection side surface 12 with at least a portion of the conductive layer 14 being covered with the reflective layer 12a; and the heat dissipation layer 13 that is provided on the side of the reflection side surface 12 opposite to the side on which the reflective layer 12a is provided. For example, the thickness of the heat dissipation layer 13 is thicker than the thickness of the conductive layer 14.

To improve the heat dissipation, the surface area of the heat dissipation layer 13 is set to be as large as possible. In other words, in the embodiment, for example, the surface area of the heat dissipation layer 13 is greater than the surface area of the conductive layer 14. Thereby, good heat dissipation is easily obtained.

The polyimide layer that is used as the substrate 10 functions as electrical insulation and as a heat dissipation path. It is favorable for the thickness of the substrate 10 to be, for example, not less than 12 μm and not more than 38 μm. By setting the thickness to be not less than 12 μm, good electrical insulation (withstand voltage) is easily obtained. By setting the thickness to be not more than 38 μm, a heat dissipation path (reduced thermal resistance) is ensured easily. However, the embodiment is not limited thereto. The thickness is arbitrary.

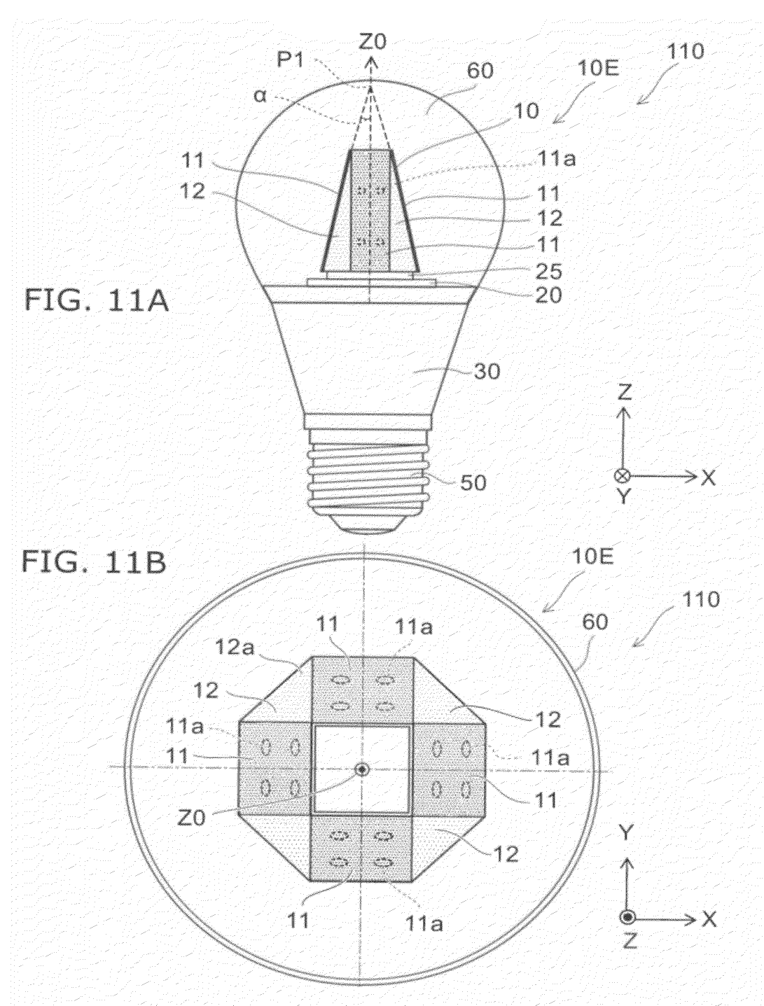

FIG. 11A and FIG. 11B are schematic views illustrating the configuration of the lighting apparatus according to the embodiment.

These drawings illustrate the relationship between the light emitting unit 10E and the enclosure 60 of the lighting apparatus 110.

As illustrated in FIG. 11A, the planes extending upward as extensions of the light emission side surfaces 11 intersect the central axis Z0 at the intersection P1. The intersection P1 is on the side of the enclosure 60 toward the light emitting unit 10E. In other words, the planes extending upward as extensions of the multiple light emission side surfaces 11 intersect each other inside the space around which the enclosure 60 is provided (e.g., at the intersection P1).

Thereby, the uniformity of the intensity of the light emitted from the enclosure 60 to the outside improves. Thereby, for example, the degree of the scattering properties provided to the enclosure 60 is reduced. Thereby, for example, the optical transmittance of the enclosure 60 can be increased; and the efficiency can be increased.

In other words, in the embodiment, the tilt angle α of the light emission side surface 11 of the substrate 10 of the light emitting unit 10E is appropriately set based on the specifications of the enclosure 60 (e.g., the height and the like of the enclosure 60).

As described above, in the embodiment, the tilt angle α can be modified easily by modifying the configuration of the reflection side surface 12 without modifying the design of the light emission side surface 11 because the light emission side surface 11 and the reflection side surface 12 are provided. Thus, in the embodiment, the design to set the tilt angle α can be easier; and the practical usability is high.

As illustrated in FIG. 11B, the substrate 10 of the light emitting unit 10E is disposed at, for example, a position centered on the central axis Z0. The enclosure 60 also is disposed at a position centered on the central axis Z0. In other words, the center of the circle circumscribing the tubular portion of the substrate 10 when the tubular portion is viewed along the first axis (e.g., the central axis Z0) substantially matches the center of the circle circumscribing the lower end of the enclosure 60 when the lower end of the enclosure 60 is viewed along the first axis. Thereby, the light emitted from the light emitting unit 10E is uniformly incident on the enclosure 60. Further, the uniformity of the light emitted from the enclosure 60 to the outside increases.

According to the embodiment, a practical lighting apparatus having a wide light distribution angle is provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in lighting apparatuses such as substrates, light emitting devices, reflective layers, base units, bodies, base caps, enclosures, and the like from known art; and such practice is included in the scope of the invention to the extent that similar effects are obtained.

Moreover, all lighting apparatuses practicable by an appropriate design modification by one skilled in the art based on the lighting apparatuses described above as embodiments of the invention also are within the scope of the invention to the extent that the spirit of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A lighting apparatus, comprising:
a base unit; and
a light emitting unit provided on the base unit,
the light emitting unit including:
a substrate provided around a first axis, the first axis being along a direction from the base unit toward the light emitting unit, the substrate including a portion having a tubular configuration opening downward from above, the tubular portion including a plurality of light emission side surfaces disposed alternately around the first axis with a plurality of reflection side surfaces;
a light emitting device provided on each of the plurality of light emission side surfaces; and
a reflective layer provided on each of the plurality of reflection side surfaces, the reflective layers being configured to reflect at least a portion of light emitted from the light emitting devices.

2. The apparatus according to claim 1, wherein:
one of the plurality of light emission side surfaces has a light emission side surface upper end width and a light emission side surface lower end width, the light emission side surface upper end width being a width of an upper end of the one of the plurality of light emission side surfaces, the light emission side surface lower end width being a width of a lower end of the one of the plurality of light emission side surfaces, the light emission side surface upper end width and the light emission side surface lower end width being light emission side surface widths along a direction perpendicular to the first axis;
one of the plurality of reflection side surfaces has a reflection side surface upper end width and a reflection side surface lower end width, the reflection side surface upper end width being a width of an upper end of the one of the plurality of reflection side surfaces, the reflection side surface lower end width being a width of a lower end of the one of the plurality of reflection side surfaces, the reflection side surface upper end width and the reflection side surface lower end width being reflection side surface widths along a direction perpendicular to the first axis; and
a ratio of the light emission side surface upper end width to the light emission side surface lower end width is greater than a ratio of the reflection side surface upper end width to the reflection side surface lower end width.

3. The apparatus according to claim 1, wherein each of the plurality of reflection side surfaces is a triangle.

4. The apparatus according to claim 1, wherein each of the plurality of light emission side surfaces is a rectangle.

5. The apparatus according to claim 1, wherein the reflective layer has a portion extending from the reflection side surface onto at least a portion of an outer edge portion of the light emission side surface.

6. The apparatus according to claim 1, wherein the reflective layer includes a silicone resin and a fine particle dispersed in the silicone resin.

7. The apparatus according to claim 1, wherein the light emitting device is multiply provided in each of the plurality of light emission side surfaces, a first group of the multiple light emitting devices is connected in series to each other, a second group of the multiple light emitting devices is connected in series to each other, and the number of the light emitting devices included in the first group is the same as the number of the light emitting devices included in the second group.

8. The apparatus according to claim 1, further comprising an enclosure covering the light emitting unit, wherein planes extending upward as extensions of the plurality of light emission side surfaces intersect each other inside a space defined by the enclosure.

9. The apparatus according to claim 1, further comprising an enclosure covering the light emitting unit,
a center of a circle circumscribing the tubular portion of the substrate when the tubular portion is viewed along the first axis being configured to match a center of a circle circumscribing a lower end of the enclosure when the lower end of the enclosure is viewed along the first axis.

10. The apparatus according to claim 1, wherein:
the light emitting unit further includes
a conductive layer provided on the reflection side surface, at least a portion of the conductive layer being covered with the reflective layer, and
a heat dissipation layer provided on the reflection side surface, the reflection side surface being disposed between the heat dissipation layer and the reflective layer; and
a surface area of the heat dissipation layer is greater than a surface area of the conductive layer.

11. The apparatus according to claim 10, wherein a thickness of the conductive layer is not less than 12 μm and not more than 70 μm.

12. The apparatus according to claim 1, wherein:
the reflective layer includes a portion provided on the light emission side surface.

13. The apparatus according to claim 1, wherein the light emitting unit further includes:
an outer edge layer provided along an outer edge of each of the plurality of light emission side surfaces; and
a wavelength conversion layer filled into an inner side of the outer edge layer for each of the plurality of light emission side surfaces to cover the light emitting devices, the wavelength conversion layer being configured to absorb at least a portion of the light emitted from the light emitting devices to emit light of a wavelength different from a wavelength of the light emitted from the light emitting devices.

14. The apparatus according to claim 13, wherein a thickness of the wavelength conversion layer is thicker than a thickness of the reflective layer.

15. The apparatus according to claim 1, wherein a thickness of the reflective layer is not less than 20 μm and not more than 50 μm.

16. The apparatus according to claim 1, wherein a thickness of the substrate is not less than 12 μm and not more than 38 μm.

17. The apparatus according to claim 2, wherein the ratio of the light emission side surface upper end width to the light emission side surface lower end width is not less than 0.8 and not more than 1.

18. The apparatus according to claim 2, wherein the ratio of the reflection side surface upper end width to the reflection side surface lower end width is not less than 0 and not more than 0.5.
